(19) United States
(12) Patent Application Publication
(10) Pub. No.: US 2004/0095596 A1
(43) Pub. Date: May 20, 2004

(54) Apparatus, method and program product for controlling printing

(75) Inventor: Nenad Rijavec, Longmont, CO (US)

Correspondence Address: IBM CORPORATION, PO BOX 12195, DEPT 9CCA, BLDG 002, RESEARCH TRIANGLE PARK, NC, 27709, US

(73) Assignee: INTERNATIONAL BUSINESS MACHINES CORPORATION, ARMONK, NY

(21) Appl. No.: 10/065,745

(22) Filed: Nov. 14, 2002

(51) Int. Cl. G06F 3/12; G06F 9/28; G06F 13/10

(52) U.S. Cl. 358/1.15; 719/321; 708/233

(57) ABSTRACT

A print controller, method and program product in which print stream data is received, parsed into local and global portions, packaged for further raster image processing, and then processed in parallel by a plurality of raster image processors.

### FIELD AND BACKGROUND OF THE INVENTION

This invention relates to controlling printing in high speed color printing apparatus.

High speed color printing requires significant computing and communications resources. At 8 bits per spot, 600 dots per inch, each letter size page contains roughly 128 MB of uncompressed data in the CMYK color space. The print streams use much less data to describe each page by describing the page using a variety of architectures, such as MO:DCA, PostScript and PCL. This allows the print servers to generate even sophisticated output relatively quickly.

Print engines, on the other hand, require bitmaps, so the printer controllers, such as the IBM Advanced Function Common Control Unit (AFCCU) must transform or rasterize the input data into bitmaps. Raster image processing is also known as “rip” or “ripping” in preparation for delivery of a data stream to a printhead. Current high end color printers work at 130+ pages per minute and at that rate strain the available computational resources. The next generation color printers will run at speeds of 2000+ pages per minute. While the printheads themselves might not support 8 bits per spot, the print data is still usually specified at that bit depth and halftoned in the printer.

High speed printers tend to be based on continuous form technology. In this technology, the printheads must be fed at rated speed, or the engine must stop, or blank pages must be emitted. Using current electrophotographic printheads, each side has four heads that share a single fuser, and so some blank paper is always emitted. This is not only wasteful and expensive, but also tends to disrupt postprocessing equipment.

Inkjet printers currently under development will be able to avoid emitting blank paper through reversing the paper, but still the backhitching caused by control unit underruns will cause productivity losses, engine wear and output quality problems. For this reason, every effort will be made by the controller manufacturers to maintain the rated speed.

In high speed color printing, maintaining the rated speed is achieved by severely limiting the structure of data that can be printed, requiring the print data generators to generate “efficient” data. For example, continuous tone images must be generated using the right size, resolution and orientation, so no image processing is done in the printer. Heavy use is also made of specialized hardware for operations like screening, merging, upsampling and decompression. In addition, large shared memory multiprocessor machines are used as printer controllers.

Alternatively, the controllers are built to operate in “pre-rip” mode where each job is ripped in advance and saved to disk “close” to the printheads. This approach is not practicable for statement printing and similar applications that require long runs of unique or heavily varying pages.

Current rip-and-print solutions leave much to be desired. The custom hardware is expensive to develop and difficult to modify. The printstream restrictions impose severe burdens on the application generators and customers. Finally, the required large print servers and controllers can double the price of the printer. To support much higher throughputs, all of these shortcomings will become even more pressing.

### BRIEF SUMMARY OF THE INVENTION

With the foregoing in mind, it is a purpose of this invention to propose a radically different design for a high speed print controller. Instead of custom hardware and expensive fast multiprocessor machines, the controller is designed to use cheap commodity processors such as commercial, off the shelf, personal computer systems. Traditionally, such an approach has not been considered viable, since the commodity machines lacked high enough I/O and memory performance to be useful. This invention proposes to avoid this problem by introducing page pipelining, so that rasterized bitmaps are not returned to a common point. In this way, processing requirements on each part of the system are drastically lessened.

As a result, a print controller has much higher performance and lower cost than currently feasible. In addition, as commodity processors and commercially available networks are improved, the performance can be increased in a straightforward manner. By using the design described here, each controller can be configured, by adding RIP machines and connecting networks, to suit the needs of each customer.

### BRIEF DESCRIPTION OF THE SEVERAL VIEWS OF THE DRAWINGS

Some of the purposes of the invention having been stated, others will appear as the description proceeds, when taken in connection with the accompanying drawings, in which:

FIG. 1 is a schematic representation of an apparatus in accordance with this invention as combined with a print server and a printer;

FIG. 2 is a schematic representation of a controller apparatus in accordance with this invention;

FIG. 3 is a schematic representation of the steps performed by the apparatus of FIGS. 1 and 2 performing in accordance with this invention; and

FIG. 4 is a representation of a computer readable medium bearing computer executable instructions causing performance of the method steps of FIG. 3.

### DETAILED DESCRIPTION OF THE INVENTION

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of the invention. Accordingly, the description which follows is to be understood as being a broad, teaching disclosure directed to persons of skill in the appropriate arts, and not as limiting upon the present invention.

At the outset, it is useful to review certain terminology which will be used in the following discussions. A “print job” typically is a data file stored accessibly to an information handling system such as a high function personal computer or a network server. The data file may have been originated in a number of ways known to printing technologists, including original document keying, scanning, use of graphics design programs, and the like. The print job may be understood as defining a sequence of pages. A page is one surface of a sheet. The sheet may be a cut sheet, as in a single piece of what is known to most as letter size paper, or a continuous roll. With two surfaces, a sheet may receive two pages. In transferring a print job to a printer, an operator will create a “job ticket” which describes to the printer or print server the control functions necessary to cause the print job to appear on the finished pages as desired by the originator. These control functions may include incorporation of special features or elements, repetition from one page to another of certain features or elements, changes in fonts or paper, and the like.

Instructions such as those in a job ticket are expressed in a particular data stream, such as the Intelligent Printer Data Stream (IPDS). In alternative embodiments, alternative data streams may be employed, such as PostScript, Hewlett-Packard Printer Control Language (PCL), Printer Job Language (PJL) or Apple Talk Printer Access Protocol (PAP). However, preferably, the data stream employed is both architected and bi-directional. By “architected” what is meant is, a standardized set of controls is transmitted with raw data which specifies how the data is to be presented. By “bi-directional” what is meant is, a synchronization mechanism is provided between the host (e.g., a print server or other data stream generator) and the receiver (e.g., a printer or other output device) allowing them to synchronize at various points in the data stream. For example the host and the receiver may be able to synchronize at a command or page-level according to an acknowledgment protocol which provides for the exchange of host-initiated queries and receiver reply information. Also, while embodiments of the present invention will be described with reference to a particular transport level protocol (also referred to as a carrying protocol or communications protocol), i.e., transmission control protocol (TCP), other protocols that provide error-free, bi-directional byte stream between two endpoints may be employed, such as Xerox Network Systems (XNS), S/370 Parallel Channel Host Attachment, or the like. The controller described hereinafter as particularly exemplary of the present invention may, for example be inserted functionally between what are here described as a host and a receiver.

An important concept in this invention is pipelined page handling. In the current controller designs, each page may be ripped in parallel by a different processor, but they are reassembled and spooled to the head assembly from a single point. Bus contention and memory access (even blanking the memory at needed speed is a challenge) are major bottlenecks.

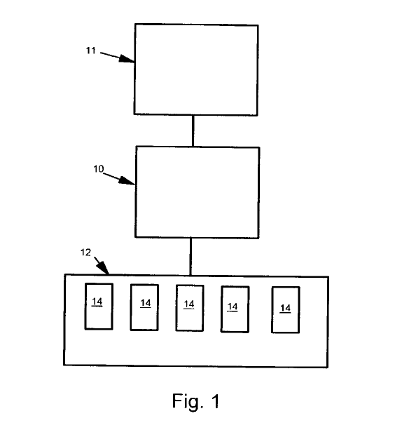

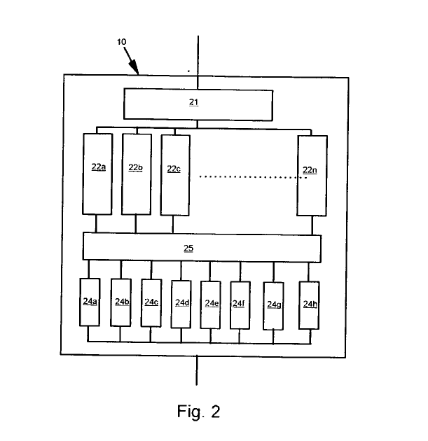

Referring now more particularly to the accompanying drawings, a print controller in accordance with this invention is shown in FIG. 1 and identified generally at 10. As here shown, the print controller comprises a number of elements represented separately, as will be here described with reference to FIG. 2. However, it is to be understood from the outset that the present invention contemplates that the functions here shown and described separately may be consolidated in various ways and combinations while remaining within the scope of the present invention.

In the arrangement of FIG. 1, the controller 10 is interposed between a print server 11 and a printer 12. The printer 12 has a plurality of print heads 14. While not here shown in detail, persons of skill in the art of printers, and particularly with regard to high speed color printers using roll feed, will understand that print heads may be provided for the front and back of a sheet, to print pages on the two surfaces of the sheet, and for the various colorants necessary for multicolor printing such as CMYK.

The design proposed here breaks the printer controller 10 into a pipeline with three logical stages. In the most general implementation, each stage is run on one or more separate machines. In other implementations contemplated by this invention the stages may be consolidated into a smaller number of machines or even a single machine having sufficient processing capability to perform the necessary computational steps. The pipeline stages are described hereinafter with reference to FIG. 2.

The first stage is a sequencer 21 which receives a data stream from a print server. It handles all the communication and assembles and reports back all the necessary acknowledgments and error messages. The sequencer 21 is the “main coordinator” in the controller and knows which page is at which point in the pipeline.

As mentioned hereinabove, print pages defined by the data stream passed from a print server can be said to contain two types of data: local and global. Local data impacts just the current page. Global data, even though it is contained within a print page, changes the global print state and thus impacts the succeeding pages. Global data may also be present between the pages. The sequencer 21 analyzes the input pages and updates the global state. Note that the sequencer does not need to parse the input data completely, just enough to identify global operations. As a practical matter, the sequencer can operate on multiple pages at once, with each page generating a “delta” to the global state. The sequencer then packages each page with the global state that was valid at the time the page was started. The page/state combination is now independent and can be processed separately from all other pages. Note that the sequencer 21 may package work in other units, so that for example all the pages on a single sheetside are packaged as a unit.

The sequencer maintains a queue of the independent work units that were generated in this way. This queue is accessed by the Page RIP processors in the next pipeline stage.

The Page RIP pipeline stage 22 contains, in the illustrated form, a number of separate RIP machines 22a, 22b, 22c . . . 22n. To minimize the network contention, these machines may be connected to the sequencer 21 using multiple physical networks. Note that the system can be organized in such a way that the sequencer-to-page rip networks are loaded significantly less than the network connection from the print server to the sequencer 21.

Each time a RIP machine can accept another work unit, it contacts the sequencer 21 and obtains the next unit of work. Depending on the size and speed of the RIP machines, each may be working on multiple work units. Note also that the RIP machines can be of varying sizes and may be significantly different than the sequencer. For example, the sequencer 21 may be a high end machine with excellent I/O performance, while the RIP machines 22a et seq may be much cheaper and slower. Also note that this design, where each RIP machine requests more work when ready, provides for automatic load balancing.

If a RIP machine encounters an error, this is reported back to the sequencer 21. As each work unit is RIPed, a number of bitmaps are produced. The number can be either zero (blank page), 1 (single color), 4 (CMYK) or even more if the print engine uses more than four colors. Each RIP machine knows if the work unit is to be printed on the front or the back of the sheet and thus which heads will be used. The RIP machine reports that the unit was done to the sequencer and then sends the bitmaps to the next pipeline stage, the head drivers 24a et seq. If any bitmap is empty, this fact is reported to the relevant head driver.

This communication is an important point, since the bitmaps might be very large. For this reason, the RIP-to-head driver communication may be split into multiple networks, shown in FIG. 2 at 25 as being interposed between the RIP machines 22a et seq and the head drivers 24a et seq. As an extreme case, each head driver might have a dedicated network. A more reasonable approach would be to have black heads on two dedicated networks since they probably have most data to print and other heads might share networks in some manner.

Head drivers 24a et seq accept the bitmaps from the RIP machines 22 and send them to the actual heads 14 in the printer 12. Since each sheetside will take different amounts of time to process, the bitmaps may arrive out of sequence. The head driver puts the received bitmaps in the right sequence and sends them to the heads in proper order.

When a RIP machine completes an assigned task, the sequencer 21 may function as a synchronizer, issuing a command to the RIP machine to send the appropriate colorplanes of processed sheetsides as needed by the print head drivers 24a et seq. Depending upon the available processing capability, the sequencer and synchronizer functions may be performed by a system which also functions as a RIP machine. Alternatively, the functions may be separated or combined in others ways as by having one RIP machine 22a also function as the sequencer 21 while another RIP machine 22b also functions as the synchornizer.

Alternatively, some implementations may prefer to use a different intermediate format between the RIP machines and head drivers, instead of bitmaps. There are a number of possible strategies, each presenting a different tradeoff between the required bandwidth and the required processing by the head driver.

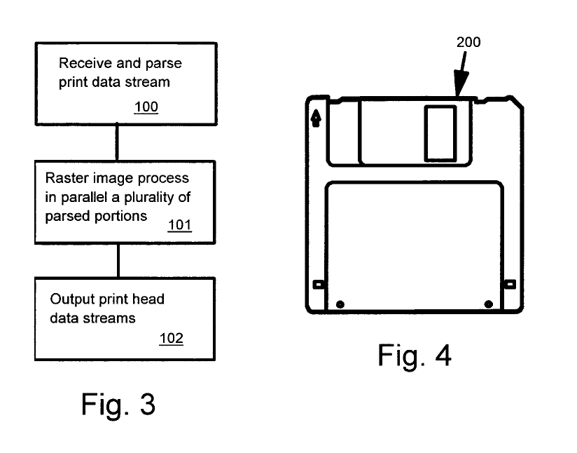

Understood broadly, the present invention performs a sequence of steps as schematically illustrated in FIG. 3. As there shown, an incoming print data stream is received and parsed into local portions at 100. The local portions are then passed to a plurality of RIP machines and processed in parallel in a plurality of raster image processing machines at 101 to produce print head data streams appropriate to drive the print heads of an associated printer, here described as being bitmap data streams. The print head data streams are output at 102 to the print head drivers of an appropriate printer.

The present invention may be provided as a computer program product which may include a machine-readable medium 200 (FIG. 4) having stored thereon instructions which may be used to program a computer (or other electronic devices), to perform a process according to the present invention and as illustrated in FIG. 3. The machine-readable medium may include, but is not limited to, floppy diskettes, optical disks, CD-ROMs, magneto-optical disks, ROMs, RAMs, EPROMs, EEPROMs, magnetic or optical cards, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or a network connection).

In the drawings and specifications there has been set forth a preferred embodiment of the invention and, although specific terms are used, the description thus given uses terminology in a generic and descriptive sense only and not for purposes of limitation.

What is claimed is:

1. Apparatus comprising: a pipeline of elements processing print control data and having: a plurality of print head drivers, each of which controls the application of colorant to a sheet and has an input port receiving data signals; a plurality of raster image processors, each of which has an output port communicating with the input ports of said plurality of print head drivers to deliver thereto data signals controlling the application of colorant to a sheet and an input port receiving parsed page data; and a sequencer which has an output port which communicates with the input ports of said plurality of raster image processors and an input port receiving a print data stream, said sequencer monitoring data flows among the pipelined elements and parsing a print data stream into local data portions related to individual pages and global state data portions related to characteristics shared across a plurality of pages, said sequencer packaging together parsed page local and global state data portions; said raster image processors processing in parallel packaged parsed page data related to a plurality of pages and generating data signals to be communicated to said print head drivers as directed by said sequencer.

2. Apparatus according to claim 1 wherein said sequencer queues packaged individual page data to be communicated to said raster image processors and further wherein individual ones of said raster image processors draw from said queued data as processing of data related to an individual page is completed and generated data signals are communicated to a print head driver.

3. Apparatus according to claim 1 wherein each of said raster image processors converts data from a form communicated as a print data stream to a form to be communicated as data signals to a print head driver.

4. Apparatus according to claim 3 wherein each of said raster image processors converts data from a form communicated as a print data stream into a variable number of portions depending upon whether an individual page is to be blank or be printed with a single color or to be printed with multiple colors.

5. Apparatus comprising: a pipeline of elements processing print control data and having a plurality of print head drivers, each of which controls the application of colorant to a sheet and has an input port receiving data signals; a plurality of raster image processors, each of which has an output port communicating with the input ports of said plurality of print head drivers to deliver thereto data signals controlling the application of colorant to a sheet and an input port receiving parsed page data; and a sequencer which has an output port which communicates with the input ports of said plurality of raster image processors and an input port receiving a print data stream, said sequencer monitoring data flows among the pipelined elements and parsing a print data stream into local data portions related to individual pages and global state data portions related to characteristics shared across a plurality of pages, said sequencer packaging together parsed page local and global state data portions; said plurality of raster image processors processing packaged parsed page data related to a plurality of pages in parallel and generating data signals to be communicated to said print head drivers as directed by said sequencer, each of said raster image processors converting data from a form communicated as a print data stream into a variable number of bit maps depending upon whether an individual page is to be blank or be printed with a single color or to be printed with multiple colors.

6. A method comprising the steps of: receiving a print data stream and parsing the stream into local and global portions; packaging together parsed local and global print stream data portions; queuing packaged print stream data portions; communicating queued packaged print stream data portions to a plurality of raster image processors; processing a plurality of communicated packaged print stream data portions in parallel to generate print head driving data signals; and communicating the generated print head driving data signals to the print heads of a printer.

7. A method according to claim 6 wherein said step of packaging print stream data portions comprises packaging portions applicable to individual pages.

8. A method according to claim 6 wherein said step of processing comprises generating bit map data signals.

9. A program product comprising: a computer readable medium; and program instructions stored on said medium accessibly to a computer system and effective when executing on the computer system to cause the system to: receive a print data stream and parse the stream into local and global portions; package together parsed local and global print stream data portions; queue packaged print stream data portions; communicate queued packaged print stream data portions to a plurality of raster image processors; process a plurality of communicated packaged print stream data portions in parallel to generate print head driving data signals; and communicate the generated print head driving data signals to the print heads of a printer.
